(19) United States
(12) Patent Application Publication
(10) Pub. No.: US 2026/0057402 A1
(43) Pub. Date: Feb. 26, 2026

(54) SYSTEMS AND METHODS FOR VISIT ATTRIBUTION FROM TELEMATIC CAR DRIVING DATA

(71) Applicant: Precisely Software Incorporated, Burlington, MA (US)

(72) Inventors: Cheng Qian, Jersey City, NJ (US); Stefan Heinze, Brooklyn, NY (US)

(21) Appl. No.: 18/812,188

(22) Filed: Aug. 22, 2024

(51) Int. Cl. G06Q 30/0204; G06V 20/10

(52) U.S. Cl. CPC G06Q 30/0205; G06V 20/176

(57) ABSTRACT

Systems and methods for estimating visitation rates at a physical location in which predetermined relationships are identified among associated cluster of candidate polygons associated with each of a plurality of physical locations. Telematic data received from a vehicle is used to identify a location of the vehicle during a visitation event. Ranks are assigned to the candidate polygons based on both the predetermined relationships and a distance between the vehicle and the candidate polygons. The ranks can be aggregated with information from further visitation events to estimate visitation rates for the plurality of physical locations, and the estimated visitation rates can be stored in a memory.

### TECHNICAL FIELD

The present disclosure relates generally to visitation of places and, more specifically, to identifying visitation rates for places based on location information.

### BACKGROUND

In the context of certain places, such as brick-and-mortar business locations, it is useful to know who is visiting your location and when. This type of visitation information can be useful in determining the effectiveness of advertising campaigns and, thus, can be used as an additional tool to determine when, where, or how to provide advertising messages to consumers. In some instances, the visitation information assist in managing a business. For example, a retail business may staff a greater number of employees at times when the business is expected to have a relatively high number of visitors.

Unfortunately, visitation information can be difficult to obtain. For example, users typically do not report their visits to a location in any reliable manner. In some instances, the number of persons that visit a location can be counted, but such a task can be tedious and may not provide much, if any, information about the demographics of the visitors or what motivated them to visit the location. Previously, companies have developed methods for determining whether a device visited a store (visit attribution) from location data collected from mobile phones.

More recently, telematic automotive driving data have become available for use in movement data analyses. Visit attribution of telematic automotive data presents a new set of challenges and opportunities compared with mobile device data. For instance, a mobile device that visited a grocery store might ping at the geographic coordinate that lies within the grocery store building footprint. However, a car that visited a grocery store would not ping inside the building, but rather at a nearby parking lot. In addition, pings from mobile phone location data are not tagged with metadata that denote the status of the device, while telematic automotive driving data do contain such metadata. In view of these differences, new systems and methods are needed that more effectively attribute visits from telematic automotive driving data.

### SUMMARY

In accordance with this disclosure, systems and methods for transforming raw telematics data into place visitation data are provided. In one aspect, method for estimating visitation rates at a physical location is provided. The method can include defining, in a geographic information system, candidate polygons associated with each of a plurality of physical locations; identifying predetermined relationships among associated clusters of the candidate polygons; receiving, from a vehicle, telematic data indicative of a location of the vehicle during a visitation event; assigning ranks to the candidate polygons based on both the predetermined relationships and a distance between the vehicle and the candidate polygons; aggregating the ranks with information from further visitation events to estimate visitation rates for the plurality of physical locations; and storing the estimated visitation rates in a memory.

In another aspect, a non-transitory computer-readable medium storing computer program instructions for processing indicated locations of vehicles configured for estimating visitation rates at a physical location, the computer program instructions, when executed by one or more processors, effectuating operations of the above method.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a schematic plan view of a system for transforming raw telematics data into place visitation data according to an embodiment of the presently disclosed subject matter;

FIG. 2A is a graphical representation of a geographic information system in which geographic features are represented as polygons according to an embodiment of the presently disclosed subject matter;

FIG. 2B is a graphical representation of a geographic information system in which historical mobile data is represented as weighted connections between geographic features according to an embodiment of the presently disclosed subject matter;

FIG. 2C is a graphical representation of a geographic information system in which modified polygons representing aggregated groups of geographic features are generated according to an embodiment of the presently disclosed subject matter;

FIG. 3 is a block diagram that illustrates a system for visit attribution according to an embodiment of the presently disclosed subject matter;

FIG. 4 is a flow chart illustrating a method for estimating visitation rates at a physical location according to an embodiment of the presently disclosed subject matter; and

FIG. 5 is a block diagram that illustrates an exemplary computer system according to an embodiment of the presently disclosed subject matter.

### DETAILED DESCRIPTION

As discussed in more detail below, provided are systems and methods for using raw telematic automotive driving data for determining various data metrics that characterize visitation information at a given location, referred to herein as “Place Intelligence Metrics” or “PIMs”. In some embodiments, a PIM for a given place may reflect a number of persons that have physically visited the place over a relevant period of time. For example, a PIM for a retail store may reflect the number of persons that traveled to the store over a given hour, day, week, month, year, or the like. In some embodiments a PIM may be indicative of a rate at which persons from a given location (e.g., within a particular radius or geographic cell) visit a place. In some embodiments, determination of PIMs may be a portion of a larger marketing effort. For example, the data represented in a PIM can be used as an input for an overall marketing campaign that may include identifying user profiles, identifying places of interest, providing marketing content (e.g., advertisements) related to the places of interest, determining PIMs for the places of interest, identify target groups of people based at least in part on the PIMs, and providing targeted marketing content (e.g., targeted advertisements) to the identified groups of people.

Although certain embodiments are described herein with regard to certain types of places (e.g., retail stores having brick-and-mortar locations) for the purposes of illustration, similar embodiments can be employed for any variety of places. For example, PIMs can be determined for airports, train and bus stations, sports stadiums, landmarks, parks or other places for which visitation information is desirable. As discussed above, however, determining visitation rates using telematic automotive driving data can be challenging since, when a user visits a location, the user's vehicle does not ping inside the building, but rather at a nearby street or parking lot where the user exited the vehicle.

Accordingly, the present systems and methods are configured to coordinate the telematics automotive driving data with information regarding predetermined relationships between vehicle locations and nearby physical locations to estimate place visitations. In some embodiments, the beginning of a visitation event is associated with an indication that the vehicle is turned off, and the end of the visitation event is associated with an indication that the vehicle is subsequently turned on. In some embodiments, event-level ignition metadata is used to determine when the vehicle is turned off and on. In some embodiments, the location of the visitation event is characterized by a map coordinate (i.e., latitude and longitude pair) where the vehicle was turned off, and the visitation event is characterized by a time stamp of ignition events, which can be used to identify a duration of the visitation event as the difference between the off and on events. This time spent parked in a location can only be characterized as a maximum duration since a consumer may not directly enter the store associated with the parking location or may visit multiple stores in one trip. The relevant telematics data can further include a trip identifier, which can be used to connect the visitation event to a vehicle history over a sequence of visitations.

Alternatively or in addition, the locations of vehicles may be obtained at various times. In some embodiments, the location of a vehicle is determined at regular intervals. For example, a vehicle may be configured to generate additional location datasets at regular intervals (e.g., every minute, hours, day, or the like). In some embodiments, the additional location information of a vehicle is determined in response to a query, such as location polling. For example, a vehicle may generate a location dataset in response to a “ping”by its service provider.

In some embodiments, the telematic automotive driving data can be anonymized so that the vehicle history is not connected with any individual person or identity. In addition, in some embodiments, this anonymization can include a supplier of the telematic data selectively modifying pings such that the latitude and longitude coordinates are obfuscated. For example, the data supplier may obfuscate pings near sensitive locations (e.g., frequently visited locations such as home or workplace) by truncating their latitudes and longitudes to fewer decimal places. Because the truncation of the coordinates can cause the data to no longer precisely identify the location of the vehicle, inclusion of these obfuscated pings can introduce inaccurate data into the processing by indicating visits to locations that are different than the true locations of the vehicle, perhaps even hundreds of meters away. To prevent such misattributed visitation, in some embodiments, pings with low latitude-longitude decimal precision (e.g., 2 decimal places or fewer) can be removed from the telematic automotive driving data to be analyzed.

For a given visitation event, the location of the vehicle is then compared with the nearby physical locations that are most likely to be visited. For this comparison, the surrounding area is divided into candidate polygons that are associated with each of a plurality of physical locations, and the visit events are grouped with nearby candidate polygons. In particular, in some embodiments, the candidate polygons define polygonal boundary areas for both building footprints and land parcels, which can include parking lots and adjacent streets in which a vehicle can be stopped to initiate a visitation event. In some embodiments, the process of defining the candidate polygons can include identifying the centroids of areas corresponding to the plurality of physical locations and identifying boundary polygons for the plurality of physical locations based at least in part on the plurality of centroids. In this way, for each of the plurality of physical locations, a corresponding polygonal boundary that bounds a respective geographic area can be stored in a memory.

Given that application of the present systems and methods can involve a large amounts of visit events (e.g., about 30-40 million) relative to a further large number of possible physical locations (e.g., more than about 140 million in the United States) that may need to be processed in a given day, in some embodiments, the number of downstream calculations are limited to avoid processing of all possible pairwise distance calculations. In some embodiments, for example, this selective processing can involve identifying a subset of the population of candidate polygons within a defined geographic area of the location of the vehicle, such as through the use of bounding boxes and grid keys.

Specifically, in some embodiments, the visit event coordinate is buffered by a bounding box. In some embodiments, the area to be processed is essentially an area in which there are car pings and polygons, which is described above. Bounding boxes are created as a perimeter surrounding the area having a selected boundary size (e.g., a 600m by 600m square) centered on each visit event. The visit event bounding box and the geometries of the polygons are assigned grid keys (truncated coordinates). In some embodiments, for example, grid keys can be measurements of latitudes and longitudes at a location rounded to two decimals. Visit events and polygons that overlap in the grid keys are grouped for downstream processing.

In some embodiments, generating grid keys for visit events and polygons enables visits and polygons that are near each other to be grouped together (because they have at least one grid key in common). In a parallel processing environment, the entire input data must be divided and distributed across hundreds or thousands of worker nodes to be processed. The grouping of visit and polygons by grid keys ensure that the data is distributed by group, so that all the visits and polygons within one grid key (i.e. one region) end up in the same worker node of the computing cluster. This arrangement ensures efficient parallel processing of large input datasets. Within each group, for each visit event the distance from the visit event to each polygon in the group can be calculated (e.g., the distance to the nearest perimeter) by using an R-tree structure for optimized processing. In this way, distances can be calculated using standard methods in existing libraries. Specifically, in some embodiments, a haversine formula can be used to determine the great-circle distance between two points on a sphere (i.e., the earth).

Finally, each polygon near the visit event is assigned a rank. In some use cases, the polygon(s) in the location(s) deemed most likely to be visited by the car are assigned a higher rank (e.g. a rank of “1”), and incrementally lower ranks are assigned to locations having correspondingly lower likelihoods of being visited (e.g., ranks of “2,” “3,” etc.). In some embodiments, the ranking algorithm can be based at least in part on distance between the visit event and the candidate polygons, but the present systems and methods can further take containment relationships among polygons into account. As used herein, a containment relationship involves a configuration in which a candidate polygon lies within the boundary of another of the candidate polygons. In some embodiments, containment can be partial. For example, if a polygon has greater than 50% of its area overlapping with the bounding polygon, then it is considered containment.

For instance, in some embodiments, for any polygons geo-intersected by the visit event (i.e., the visit event resides within the boundary of one of the candidate polygons), a rank of “1” can be assigned. In addition, however, the nearest contained polygon that is contained within any geo-intersected polygons is also assigned a rank of “1.” This approach is particularly useful where the polygon dataset contains both building footprints and land parcels. In this situation, the containment relationship between polygons is leveraged to assign high ranks to sub-polygons contained within geo-intersected top rank polygons (e.g., physical locations located within a larger land parcel that includes a parking lot). Beyond the geo-intersected polygons and the nearest contained polygon, in some embodiments, the remaining polygons are assigned lower subsequent ranks by distance. If the visit event does not geo-intersect any polygons, the nearby polygons are all ranked by distance.

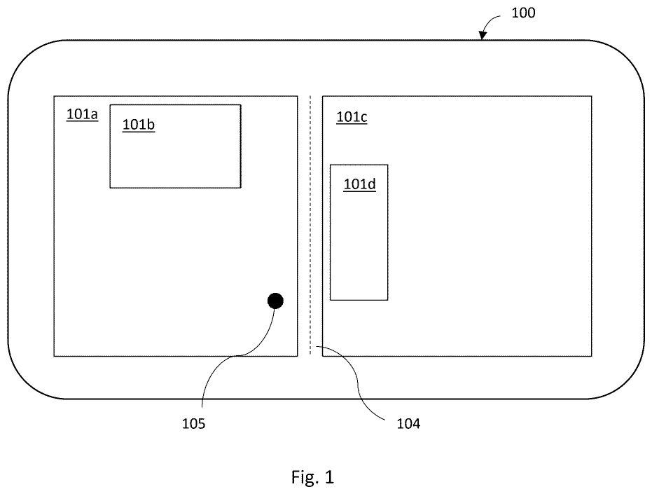

As an example, referring to an embodiment shown in FIG. 1, within a geographic information system 100, polygons corresponding to businesses and other places, points corresponding to points of interest, and lines corresponding to roads, railroad tracks, and the like may also be stored in the geographic information system 100 as geographic features. In the illustrated embodiment, a first land parcel is identified by a first polygon 101a, a first building located on the first land parcel is identified by a second polygon 101b, a second land parcel located across a street 104 from the first land parcel is identified by a third polygon 101c, and a second building located on the second land parcel is identified by a fourth polygon 101d. If a vehicle 105 initiates a visit event in a parking lot within the first polygon 101a, applying a ranking algorithm according to the present methods can result in the first polygon 101a and the second polygon 101b being assigned a rank of “1,” whereas the third polygon 101c is assigned a rank of “2,” and the fourth polygon 101d is assigned a rank of “3.” The first and second polygons 101a and 101b being the candidate polygons having a rank of “1” are deemed to be the locations visited by the vehicle 105. In this way, even though the third and fourth polygons 101c and 101d are closer in distance to the vehicle 105, they are not assigned the top rank.

In addition, in some embodiments, further characterizations can be associated with different assigned ranks in some use cases. For example, in embodiments in which the present systems and methods are used for business intelligence applications, only high confidence visits may be counted, in which case visits with a rank of “1” will be the focus of the analysis. Alternatively, in some embodiments, such as where the present systems and methods are used to provide inputs for advertising, it can be desirable to include lower confidence visits (e.g., devices that are likely to have visited, but we are not very certain) in the output, in which case the data can be filtered for visits with any rank identifying at least a general proximity to a location of interest (e.g., having a rank of 5 or lower). The inclusion of visits with only moderate confidence of visitation can be used to achieve greater scale (i.e., number of visitors).

Studies have been conducted to confirm that this ranking method that considers polygon containment relationships performs better on average than purely distance-based ranking methods. These methods can be particularly accurate in locations with chain stores with large store footprints and dedicated parking lots, businesses where consumers tend to buy large items and thus prefer parking close to the store (e.g., grocery, furniture, and hardware stores), gas stations, and generally suburban and rural areas.

Alternatively or in addition to elevating the ranking of candidate polygons based on containment relationships as discussed above, the ranking algorithm can further modify a rank of a given candidate polygon based on other predetermined associations between candidate polygons. In some embodiments, for example, information from historical mobile data is used to identify associations between polygons. In some embodiments, mobile data can be used for deduplication of data (e.g. removing duplicate pings at the same latitude and longitude within 20 minutes of each other). Further, in some embodiments, mobile data can be used for spam removal (e.g. removing pings that are not consistent with the laws of physics, e.g. travelling faster than airplane speed). In some embodiments, mobile data can be used for trajectory removal (e.g. removing the high-speed driving portions of a trip, so the actual visit-related pings at the beginning and end of a trip remain, driving trajectories are identified and removed based on speed and bearing). Removal of trajectory pings help to minimize false positive pings at stores next to roads. In any application, the geographic information system 100 can be configured to consider pairs of locations to be co-visited during the same visit event when they are close together within a predetermined time window (e.g., sequential observations within 60 minutes of each other) and/or within a predetermined relative distance (e.g., located within 80 meters).

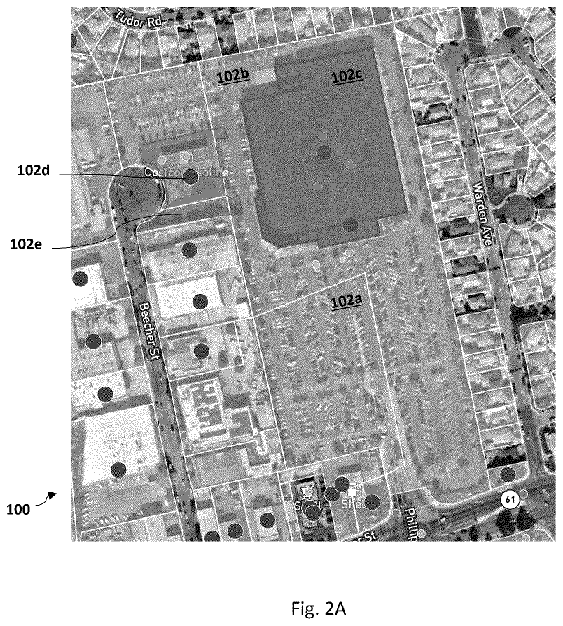

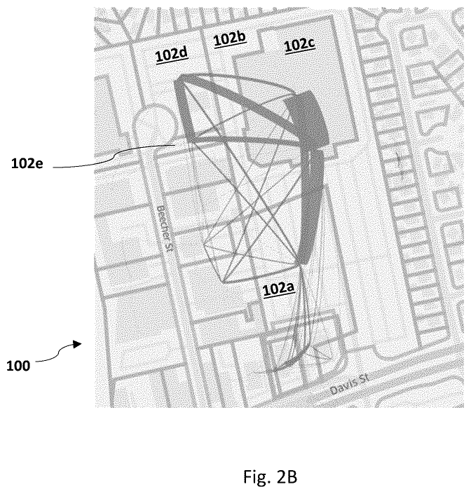

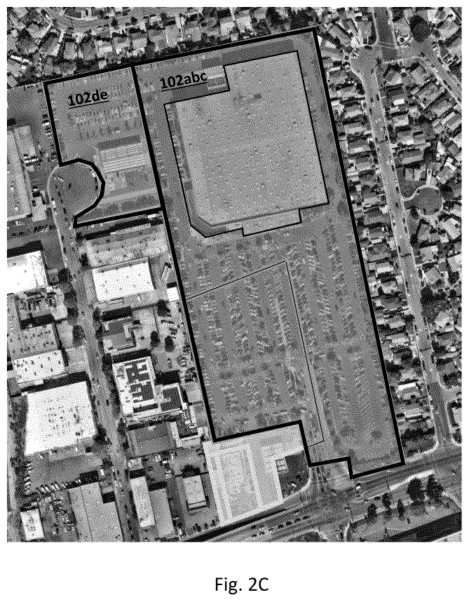

Referring to FIGS. 2A through 2C, in some embodiments, mobile data is used to identify co-visitation of different polygons by users during visits to a region containing a cluster of polygons. A section of a geographic information system 100 is shown in FIG. 2A in which a first polygon 102a identifies a parking lot outside of a physical building 102c, a second polygon 102b identifies the parcel containing the building 102c, and third and fourth polygons 102d and 102e identify further neighboring properties. Collected mobile data can be used to identify associations between the candidate polygons that are sufficient to characterize the polygons as being likely to be co-visited during a visit event. In some embodiments, for example, mobile data (e.g., smartphone data) regarding movement of a user that is close in time and space can be characterized as a visit cluster, and individual location pings within the cluster can be modelled as Gaussians whose widths are based an assigned accuracy that accompanies the ping. Such modelled Gaussians can be scored against the special layer polygons, which can give an estimate for whether a device was seen at multiple polygons within a given visit cluster. In this way, each time a pair of parcels are both identified from the collected mobile data as being visited by a user, the connection between the parcel pairs is given greater weight. Referring to FIG. 2B, for example, different thicknesses of lines are used to show relative connection strength, with thicker lines identifying stronger connections.

In some embodiments, polygon pairs having connection strengths above a defined threshold can be associated with one another in the geographic information system 100 such that assignment of a high rank to one polygon during a visit event can further trigger an equivalent high rank being assigned to the associated polygon. In some embodiments, thresholding is based on the count of co-seen visits, and the fraction of co-seen visits relative to the total number of visits at each polygon. In addition, parcel fusion can be limited to regions that are commercial. As a result, even if a polygon does not have a containment relationship with a neighboring polygon, a likelihood of co-visitation can still be identified.

Alternatively or additionally, in some embodiments, polygon pairs having high connection strengths can be combined within the geographic information system 100 such that visits to either polygon are considered visits to both polygons. Referring to FIG. 2C, for example, where a connection above a given threshold is shown between first and second polygons 102a and 102b and the building 102c, the polygons can be fused into a first aggregate polygon 102abc. Similarly, where a sufficiently strong connection is identified between third and fourth polygons 102d and 102e, the polygons can be fused into a second aggregate polygon 102de. In this configuration, where the original bounds of the first polygon 102a are geo-intersected by the visit event, a rank of “1” can be assigned to each of the first polygon 102a, the second polygon 102b, the building 102c, and the first aggregate polygon 102abc.

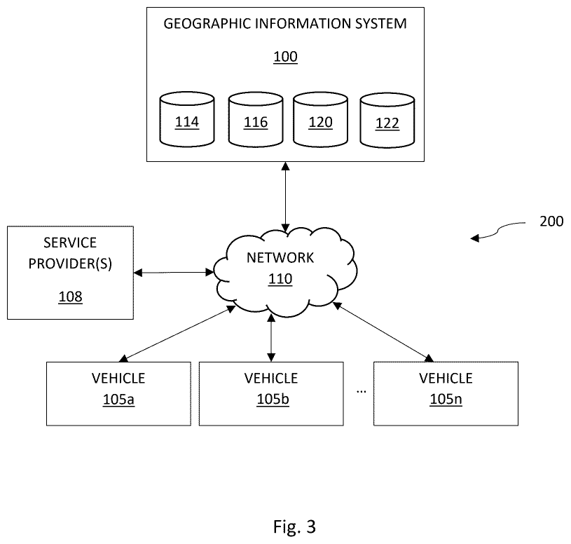

In another aspect, a system for visit attribution from telematics car driving data is provided to implement the ranking algorithm discussed above. Referring to FIG. 3, a block diagram that illustrates a system for visit attribution, generally designated 200, is illustrated in accordance with one or more embodiments of the presently-disclosed subject matter. As depicted, the system 200 includes the geographic information system 100, one or more vehicles 105 (e.g., vehicles 105a-105n), service provider(s) 108 (e.g., cellular service providers, network providers, and/or the like), communicatively coupled via a network 110. The network 110 may include an electronic communications network, such as the Internet, a local area network (LAN), a wide area (WAN), a cellular communications network and/or the like. The network 110 may include a single network or combination of networks.

In some embodiments, the system 200 is operative to determine place Intelligence Metrics (PIMs) that are stored in a PIM datastore 114. In some embodiments, the PIMs are based on vehicle location histories and vehicle profiles. In some embodiments, vehicle profiles are stored in a vehicle-profile datastore 116. Vehicle profiles may include characteristics about vehicles and/or general characteristics of their users. For example, a vehicle profile for a vehicle “a” may include a vehicle visitation history, demographics information (e.g., derived from information associated with a vehicle's most visited residential location, at either the address or census-block-group level, depending on the attribute), and/or the like. In some instances, user profile information is acquired indirectly via profiling.

In some instances, users are provided an opportunity to opt-in or out of collection and sharing of their vehicle profile information. In some embodiments, users are provided with a consent form for sharing the vehicle telematic data as part of the terms and conditions of purchasing the vehicle. For example, a user may select an option to withhold their user profile information, to share their user profile information without disclosing information by which they can be uniquely identified (e.g., a user ID), or to share their user profile information along with information by which they can be uniquely identified. Thus, vehicle profiles can be maintained in a privacy-friendly fashion.

Information regarding the places of interest and associated place characteristics, such as polygonal boundaries associated with the places, can be stored in a place datastore 120. In some embodiments, such geolocation information may not be readily available and, thus, may be difficult to obtain. The level of difficulty may increase as the number of places increases. For example, where thousands of places of interest are identified, geographic coordinates and/or polygons may need to be identified for each of the thousands of places of interest. In some embodiments, the geographic coordinates and/or the polygons may be identified using a crowdsourcing environment. In one such embodiment, a list of the places of interest and/or geographic coordinates corresponding to the respective centroids of the places of interest may be provided from the system 200 to a crowdsourcing environment. The crowdsourcing environment may outsource the tasks to a distributed group of people that identify place information, including, for example, geographic coordinates and/or polygons corresponding to the places of interest. The place information may be returned to the system 200, and the system 200 may use the place information provided via the crowd source environment to updated records for the places of interest in the place datastore 120.

In some embodiments, location histories are stored in a location datastore 122. Location histories may include records of any number of places visited by any number of vehicles. A location history for a particular vehicle may include, for example, information about one or more places visited by the vehicle. In some embodiments, location histories are based on detected locations of the vehicles. For example, where a first vehicle travels from location A, to location B to location C, and location datasets are generated that are indicative of an associated first vehicle 105a being located in each of locations A, B and C, a location history for the first vehicle 105a may include individual location datasets corresponding to each of locations A, B and C. Locations may be expressed in a variety of formats with varying degrees of specificity. For example locations A, B and C may each represent a point (e.g., geographic coordinates—latitude and longitude coordinates) or a geographic area (e.g., geographic tiles/cells of a grid with which a geographic area is segmented, or a polygon representing a physical boundaries associated with a place). Alternatively or in addition, rather than recording histories of individual vehicles and locations, the location datastore 122 can be configured to include location histories of groups/cohorts of vehicles and neighborhoods/regions vs individual locations.

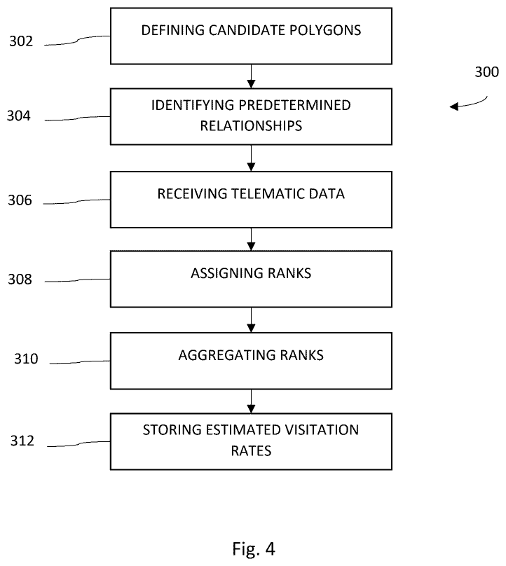

In some embodiments, location information received by system 200 is used to generate location histories stored in location datastore 122. For example, where the location dataset for location A is received in real time from vehicle 105a, and the location datasets for locations B and C are later received from a third party entity (e.g., an app server that obtained location the location datasets from vehicle 105a), the location datasets may be added to an existing location history (e.g., an existing set of location datasets) for vehicle 105a to generate an updated location history for vehicle 105a. In some embodiments, system 200 may update location histories for any number of devices in a similar manner such that location datastore 122 includes a database of updated location histories for any number of devices. The system 200 may be constructed from one or more of the computers described below with reference to at least FIG. 4. These computers may include a tangible, non-transitory, machine-readable medium, such as various forms of memory storing instructions that when executed by one or more processors of these computers (or some other data processing apparatus) cause the computers to provide the functionality of the system 200 described herein. Components of the system 200 are illustrated as discrete functional blocks, but it should be noted that the hardware and software by which these functional blocks are implemented may be differently organized, for example, code or hardware for providing the functionality may be intermingled, subdivided, conjoined, or otherwise differently arranged.

Regardless of the particular configuration of the system 200, in another aspect, the presently-disclosed subject matter provides a method for estimating visitation rates at a physical location. Referring to an embodiment shown in FIG. 4, in some embodiments, the method, generally designated 300, includes a defining step 302 in which candidate polygons are associated with each of a plurality of physical locations. In some embodiments, identifying physical locations of note includes identifying one or more places of interest. For example, where the XYZ store has ten brick-and-mortar retail locations (e.g., XYZ stores #1-10), and has expressed interested in monitoring visitation rates for the ten retail locations, the ten retail stores may be identified as places of interest. In some embodiment, identifying places includes identifying geographic locations (“geolocations”) associated therewith. For example, for a geographic location may be identified for each of the ten XYZ stores. A geolocation for a given store may include, for example, geographic coordinates that correspond to the geolocation of the store and/or a polygon defining an area associated with the store. Such a polygon may include a boundary that represents an area associated with the store (e.g., the outline of the store's building, parking lot, and/or the like). Such place information may be stored in the place datastore 120 in association with the respective places. Thus, for example, a record for the XYZ store #1 may include a geographic coordinate corresponding to the geolocation of the store (e.g., centroid of the store) and/or a polygon defining an area associated with the interior of the store. Similar records may be provided for any number of places of interest.

The method 300 can further include an identifying step 304 to establish predetermined relationships among associated clusters of the candidate polygons. As discussed above, the predetermined relationships can include containment relationship and/or co-visitation associations.

With this framework established, the method 300 can further include a receiving step 306 in which telematic data indicative of a location of a vehicle 105 is communicated regarding a visitation event. In some embodiments, the telematic data can include a vehicle identifier, a timestamp of ignition events, a latitude, and a longitude. As discussed above, in some embodiments, the receiving step 306 can include a verification that the telematic data is sufficiently precise (i.e., has location data that has not been severely obfuscated) for comparison against the candidate polygons. The method 300 can then include a ranking step 308 in which ranks are assigned to the candidate polygons based on both the predetermined relationships and a distance between the vehicle and the candidate polygons. The method can further include a sorting step 310 in which the ranks are aggregated with information from further visitation events to estimate visitation rates for the plurality of physical locations. The method 300 can then include a storing step 312 in which the estimated visitation rates are stored in a memory.

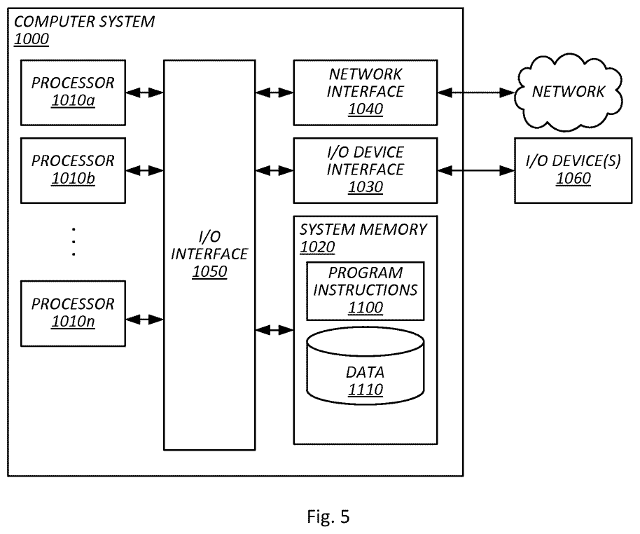

FIG. 5 is a block diagram that illustrates an exemplary computer system in accordance with one or more embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030 and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). In some embodiments, the program may be conveyed by a propagated signal, such as a carrier wave or digital signal conveying a stream of packets.

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present disclosure may be practiced with other computer system configurations.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A method for estimating visitation rates at a physical location, the computer implemented method comprising:
defining, in a geographic information system, candidate polygons associated with each of a plurality of physical locations;
identifying predetermined relationships among associated clusters of the candidate polygons;
receiving, from a vehicle, telematic data indicative of a location of the vehicle during a visitation event;
assigning ranks to the candidate polygons based on both the predetermined relationships and a distance between the vehicle and the candidate polygons;
aggregating the ranks with information from further visitation events to estimate visitation rates for the plurality of physical locations; and
storing the estimated visitation rates in a memory.

2. The method of claim 1, wherein defining candidate polygons comprises defining polygonal boundary areas for both building footprints and land parcels.

3. The method of claim 1, wherein defining candidate polygons comprises:
identifying a plurality of centroids corresponding to the plurality of physical locations;
identifying boundary polygons for the plurality of physical locations based at least in part on the plurality of centroids; and
storing, in the memory, for each of the plurality of physical locations, a corresponding polygonal boundary that bounds a respective geographic area.

4. The method of claim 1, wherein receiving, from a vehicle, telematic data comprises removing data in which the location of the vehicle has been obfuscated.

5. The method of claim 1, wherein the telematic data indicative of a location of the vehicle during a visitation event comprises a vehicle identifier, a timestamp of ignition events, a latitude, and a longitude.

6. The method of claim 1, wherein assigning ranks to the candidate polygons comprises:
identifying a subset of the candidate polygons within a defined geographic area of the location of the vehicle; and
assigning ranks only to the subset of the candidate polygons based on both the predetermined relationships and the distance between the vehicle and the subset of the candidate polygons.

7. The method of claim 1, wherein identifying predetermined relationships among associated clusters of the candidate polygons comprises identifying a first candidate polygon that has one or more other candidate polygons contained within the first candidate polygon; and
wherein assigning ranks to the candidate polygons comprises:
when the first candidate polygon geo-intersects the location of the vehicle, assigning a higher rank both to the first candidate polygon and to the one or more other candidate polygons contained within the first candidate polygon; and
assigning a lower rank to remaining ones of the candidate polygons based on relative distances from the location of the vehicle.

8. The method of claim 1, wherein identifying predetermined relationships among associated clusters of the candidate polygons comprises identifying associations between a first candidate polygon and one or more other candidate polygons based on historical mobile data; and
wherein assigning ranks to the candidate polygons comprises:
when the first candidate polygon geo-intersects the location of the vehicle, assigning a higher rank both to the first candidate polygon and to the one or more other candidate polygons associated with the first candidate polygon; and
assigning a lower rank to remaining ones of the candidate polygons based on relative distances from the location of the vehicle.

9. The method of claim 8, wherein identifying associations between a first candidate polygon and one or more other candidate polygons based on historical mobile data comprises creating an association between the first candidate polygon and to the one or more other candidate polygons where the historical mobile data includes evidence of co-visitation of the first candidate polygon and to the one or more other candidate polygons at a frequency about a defined threshold.

10. The method of claim 1, comprising identifying a location history of the vehicle by indicating a plurality of time-stamped geographic locations sensed by the vehicle;
wherein each of the respective ones of the plurality of time-stamped geographic locations indicates a location of the vehicle and a given date and time associated with the location of the vehicle.

11. A non-transitory computer-readable medium storing computer program instructions for processing indicated locations of vehicles configured for estimating visitation rates at a physical location, the computer program instructions, when executed by one or more processors, effectuating operations comprising:
defining, in a geographic information system, candidate polygons associated with each of a plurality of physical locations;
identifying predetermined relationships among associated clusters of the candidate polygons;
receiving, from a vehicle, telematic data indicative of a location of the vehicle during a visitation event;
assigning ranks to the candidate polygons based on both the predetermined relationships and a distance between the vehicle and the candidate polygons;
aggregating the ranks with information from further visitation events to estimate visitation rates for the plurality of physical locations; and
storing the estimated visitation rates in a memory.

12. The non-transitory computer-readable medium of claim 11, wherein defining candidate polygons comprises defining polygonal boundary areas for both building footprints and land parcels.

13. The non-transitory computer-readable medium of claim 11, wherein defining candidate polygons comprises:
identifying a plurality of centroids corresponding to the plurality of physical locations;
identifying boundary polygons for the plurality of physical locations based at least in part on the plurality of centroids; and
storing, in the memory, for each of the plurality of physical locations, a corresponding polygonal boundary that bounds a respective geographic area.

14. The non-transitory computer-readable medium of claim 11, wherein receiving, from a vehicle, telematic data comprises removing data in which the location of the vehicle has been obfuscated.

15. The non-transitory computer-readable medium of claim 11, wherein the telematic data indicative of a location of the vehicle during a visitation event comprises a vehicle identifier, a timestamp of ignition events, a latitude, and a longitude.

16. The non-transitory computer-readable medium of claim 11, wherein assigning ranks to the candidate polygons comprises:
identifying a subset of the candidate polygons within a defined geographic area of the location of the vehicle; and
assigning ranks only to the subset of the candidate polygons based on both the containment relationships and the distance between the vehicle and the subset of the candidate polygons.

17. The non-transitory computer-readable medium of claim 11, wherein identifying predetermined relationships among associated clusters of the candidate polygons comprises identifying a first candidate polygon that has one or more other candidate polygons contained within the first candidate polygon; and
wherein assigning ranks to the candidate polygons comprises:
when the first candidate polygon geo-intersects the location of the vehicle, assigning a higher rank both to the first candidate polygon and to the one or more other candidate polygons contained within the first candidate polygon; and
assigning a lower rank to remaining ones of the candidate polygons based on relative distances from the location of the vehicle.

18. The non-transitory computer-readable medium of claim 11, wherein identifying predetermined relationships among associated clusters of the candidate polygons comprises identifying associations between a first candidate polygon and one or more other candidate polygons based on historical mobile data; and
wherein assigning ranks to the candidate polygons comprises:
when the first candidate polygon geo-intersects the location of the vehicle, assigning a higher rank both to the first candidate polygon and to the one or more other candidate polygons associated with the first candidate polygon; and
assigning a lower rank to remaining ones of the candidate polygons based on relative distances from the location of the vehicle.

19. The non-transitory computer-readable medium of claim 18, wherein identifying associations between a first candidate polygon and one or more other candidate polygons based on historical mobile data comprises creating an association between the first candidate polygon and to the one or more other candidate polygons where the historical mobile data includes evidence of co-visitation of the first candidate polygon and to the one or more other candidate polygons at a frequency about a defined threshold.

20. The non-transitory computer-readable medium of claim 11, wherein the computer program instructions, when executed by the one or more processors, further effectuate operations comprising:
identifying a location history of the vehicle by indicating a plurality of time-stamped geographic locations sensed by the vehicle;
wherein each of the respective ones of the plurality of time-stamped geographic locations indicates a location of the vehicle and a given date and time associated with the location of the vehicle.
